(19) United States
(12) Patent Application Publication
(10) Pub. No.: US 2025/0279714 A1
(43) Pub. Date: Sep. 4, 2025

(54) Integrated Voltage Regulator Circuitry and Methods

(71) Applicant: Arm Limited, Cambridge (GB)

(72) Inventors: Yimajian Yan, Santa Clara, CA (US); Javier DeLaCruz, San Jose, CA (US)

(21) Appl. No.: 19/210,239

(22) Filed: May 16, 2025

Related U.S. Application Data
(63) Continuation-in-part of application No. 18/439,234, filed on Feb. 12, 2024.

(51) Int. Cl. H02M 1/14; H02M 3/335

(52) U.S. Cl. CPC H02M 1/14; H02M 3/33569

(57) ABSTRACT

A circuit includes a plurality of switches; a coupled inductor including a primary inductor and a secondary inductor embedded in a common magnetic core; and a first capacitor. Also, the plurality of switches are configured to alternatively couple and decouple the first capacitor and the coupled inductor to regulate voltage delivered to a load. In addition, a circuit for voltage regulation includes first and second integrated voltage regulators. The first integrated voltage regulator includes a first coupled inductor. The second integrated voltage regulator includes a second coupled inductor. Also, the first and second coupled inductors are inversely coupled to enable ripple current cancellation between the first and second integrated voltage regulators.

### FIELD

This disclosure pertains to systems and devices involving voltage regulator circuits.

### DESCRIPTION OF RELATED ART

This section is intended to provide information relevant to understanding various technologies described herein. As the section's heading implies, this is a discussion of related art that in no way implies that the discussion is prior art. Generally, related art may or may not be considered prior art. Any statement in this section should be read in this light, and not as admission of prior art.

Voltage regulators, including integrated voltage regulators, are essential components in electronic devices, ensuring stable and reliable power delivery. However, traditional integrated voltage regulators designs encounter several limitations, including challenges related to high ripple currents, efficiency losses due to switching operations, and limited space within isolated packages. Conventional integrated voltage regulators cannot effectively cancel ripple currents or minimize losses, resulting in higher inductance requirements, increased package size, and lower efficiency. Furthermore, traditional circuit topologies limit the achievable conversion ratio, restricting their applicability to voltage regulation across a broad range of input and output voltage combinations.

Moreover, when transient load changes occur, conventional single-phase integrated voltage regulators often fail to respond quickly and efficiently, leading to voltage instability and reduced system reliability. Thus, there exists a pressing need in the industry for an improved integrated voltage regulator topology capable of addressing these limitations by achieving lower ripple currents, better transient response, higher conversion efficiency, and effective utilization of package substrate space.

### BRIEF DESCRIPTION OF THE DRAWINGS

Implementations of various techniques are described herein with reference to the accompanying drawings. The accompanying drawings illustrate various implementations described herein and are not meant to limit implementations of various techniques described herein.

FIG. 1 is a diagram, in accordance with certain implementations.

FIGS. 2A-2B are graphical illustrations, in accordance with certain implementations.

FIG. 3 is a graphical illustration, in accordance with certain implementations.

FIG. 4A is a diagram, in accordance with certain implementations.

FIG. 4B is a diagram, in accordance with certain implementations.

FIG. 5 is a diagram, in accordance with certain implementations.

FIG. 6 is a flow chart, in accordance with certain implementations.

FIG. 7 is a diagram, in accordance with certain implementations.

Reference is made in the following detailed description to accompanying drawings, that form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other implementations may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, and the like), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

According to one implementation of the present disclosure, a circuit (e.g., an integrated voltage regulator) for voltage regulation includes a plurality of switches; a coupled inductor including a primary inductor and a secondary inductor embedded in a common magnetic core; and a first capacitor. Also, the plurality of switches are configured to alternatively couple and decouple the first capacitor and the coupled inductor to regulate voltage delivered to a load.

According to another implementation of the present disclosure, a circuit for voltage regulation includes first and second integrated voltage regulators. The first integrated voltage regulator includes a first coupled inductor. The second integrated voltage regulator includes a second coupled inductor. Also, the first and second coupled inductors are inversely coupled to enable ripple current cancellation between the first and second integrated voltage regulators.

According to another implementation of the present disclosure, a method for voltage regulation includes: activating a plurality of switches in sequential operational stages within a switching cycle. For example, the sequential operational stages include: 1) coupling a capacitor during a first operational stage to increase current through windings of a coupled inductor; 2) decoupling the capacitor during a second operational stage, reducing current through the windings; 3) recoupling the capacitor during a third operational stage to supply energy and increase current through the windings; and 4) decoupling the capacitor during a fourth operational stage, to repeat the reduction of current.

The present invention provides an innovative integrated voltage regulator topology integrating embedded coupled inductors in a multi-phase (e.g., dual-phase) configuration to address the limitations of existing designs. In the inventive topology, each integrated voltage regulator phase includes five switches, coupled inductor windings embedded within a common magnetic core, and at least one flying capacitor. This configuration enables the integrated voltage regulator to operate through distinct operational stages (e.g., identified herein as D1, D2, D3, and D4) within each switching cycle.

According to various aspects, in the first operational stage (D1), the flying capacitor is charged while simultaneously increasing the output current. During the second stage (D2), the capacitor is disconnected, causing current through the inductors to decrease. In the third stage (D3), the flying capacitor is reconnected, providing stored energy to the inductors and again increasing the output current. The fourth stage (D4) repeats the second stage, with the capacitor disconnected and current decreasing.

One inventive aspect is the use of two circuit phases operated approximately 180 degrees out of phase relative to each other. This dual-phase operation substantially reduces ripple currents through effective cancellation, as one phase's increasing current offsets the other phase's decreasing current. Another significant advantage is the enhanced conversion ratio. By maintaining the flying capacitor voltage at approximately half the input voltage, the inventive topology reduces voltage stress across the inductors during operation. This results in significantly lower ripple currents, reduced inductance requirements, and improved efficiency compared to traditional voltage regulators. Consequently, switching losses, AC current losses, and inductor core losses are minimized, further enhancing overall conversion efficiency.

Advantageously, embedding the inductors within a shared magnetic core efficiently utilizes substrate space, enabling a compact, integrated package. The inventive integrated voltage regulator topology is broadly applicable across diverse voltage regulation configurations without being limited by specific input or output voltages. Overall, the inventive integrated voltage regulator topology delivers substantial performance improvements, including higher efficiency, lower ripple currents, improved transient responses, and optimized substrate utilization, effectively addressing key challenges in voltage regulation.

Certain definitions have been provided herein for reference. Switches refer to components configured to selectively open or close an electrical path within a circuit, thereby controlling current flow. In the context of the integrated voltage regulator circuit described herein, switches may be implemented using transistors or similar semiconductor devices capable of alternating between conductive (ON) and non-conductive (OFF) states to regulate energy transfer. A coupled inductor refers to an inductor structure including two windings (e.g., a primary winding and a secondary winding) arranged in proximity to enable magnetic coupling and mutual inductance. The windings share a common magnetic core, typically constructed from a magnetic material designed to enhance inductive coupling. The shared magnetic path provided by the common magnetic core facilitates efficient energy transfer between the primary and secondary windings, thereby improving overall efficiency and significantly reducing ripple currents through magnetic coupling effects.

A flying capacitor refers to a capacitor periodically charged and discharged during each switching cycle of the integrated voltage regulator circuit, temporarily storing energy that is transferred between circuit nodes. The flying capacitor's voltage is actively maintained at approximately half of the input voltage, strategically improving conversion efficiency and substantially reducing ripple currents within the circuit.

The operational stages (D1-D4) refer to defined sequential intervals within each switching cycle of the integrated voltage regulator circuit, wherein: during a first operational stage (D1), the capacitor is coupled to charge, simultaneously increasing current through the windings of the coupled inductor. In a second operational stage (D2), the capacitor is decoupled from the circuit, causing the current through the coupled inductor to decrease. In a third operational stage (D3), the capacitor is recoupled to the circuit, supplying stored energy back into the coupled inductor windings, thereby increasing current again. Finally, during a fourth operational stage (D4), the capacitor is again decoupled, causing current through the coupled inductor windings to decrease, thus completing one full switching cycle.

A circuit phase refers to a grouping of circuit elements (e.g., including switches, a capacitor, and a coupled inductor) that operate in coordination throughout defined sequential operational stages. In various implementations described herein, multiple circuit phases are configured identically but operated with specific phase offsets (e.g., approximately 180 degrees out of phase), thereby enabling substantial ripple current cancellation and improved overall circuit efficiency.

An integrated voltage regulator refers to a voltage regulator circuit configured as a distinct functional unit, including dedicated switches, a capacitor, and a coupled inductor. In certain aspects, within each integrated voltage regulator circuit, a separate circuit phase may be arranged to achieve inverse coupling, where coupled inductors from each phase have opposite winding polarities. This inverse coupling configuration effectively cancels or significantly reduces ripple currents at the circuit output.

Ripple current refers to the alternating or fluctuating component of current resulting from periodic switching operations within voltage regulator circuits. By employing inverse coupling of coupled inductors and operating multiple circuit phases with offset timing, ripple current within described example integrated voltage regulator circuits are substantially reduced, enhancing overall efficiency, reducing electromagnetic interference, and improving reliability. Balancing energy transfer refers to the deliberate management and control of energy transferred to and from the flying capacitor during each switching cycle. Such balancing ensures a consistent capacitor voltage so as to promote steady-state circuit performance and stable voltage regulation.

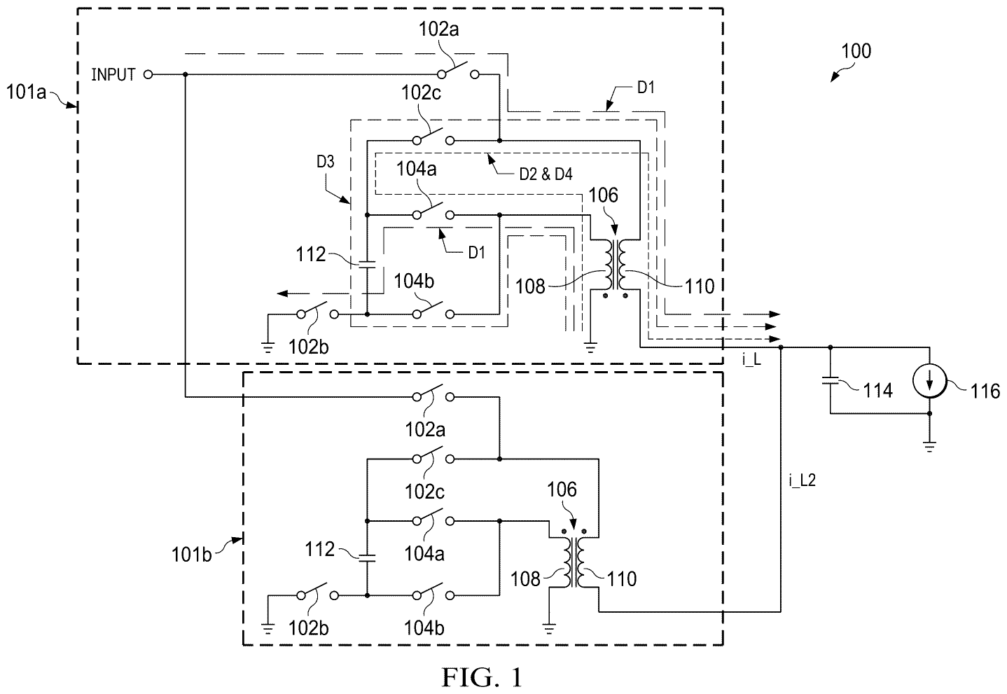

Referring to FIG. 1, a two-phase integrated voltage regulator circuit topology 100 (i.e., circuit 100; first and second integrated voltage regulator circuits) for voltage regulation is shown according to example implementations. The circuit 100 includes two operational circuit phases: a first circuit phase 101a (e.g., shown at the top portion of FIG. 1; a first integrated voltage regulator circuit) and a second circuit phase 101b (e.g., shown at the bottom portion; a second integrated voltage regulator circuit). In certain aspects, each circuit phase 101a, 101b includes a plurality of switches strategically arranged for selective coupling and decoupling operations as described herein. Specifically, the first circuit phase 101a includes switches 102a, 102b, 102c, 104a, 104b. Similarly, the second circuit phase 101b includes corresponding switches arranged identically to the first phase 101a. Each circuit phase 101a, 101b further includes a coupled inductor structure 106 including a primary winding 108 and a secondary winding 110 embedded within a common magnetic core, and at least one capacitor 112 (e.g., a flying capacitor). The circuit 100 further includes an additional capacitor 114 coupled to the output node configured to filter and stabilize the regulated voltage delivered to the load 116.

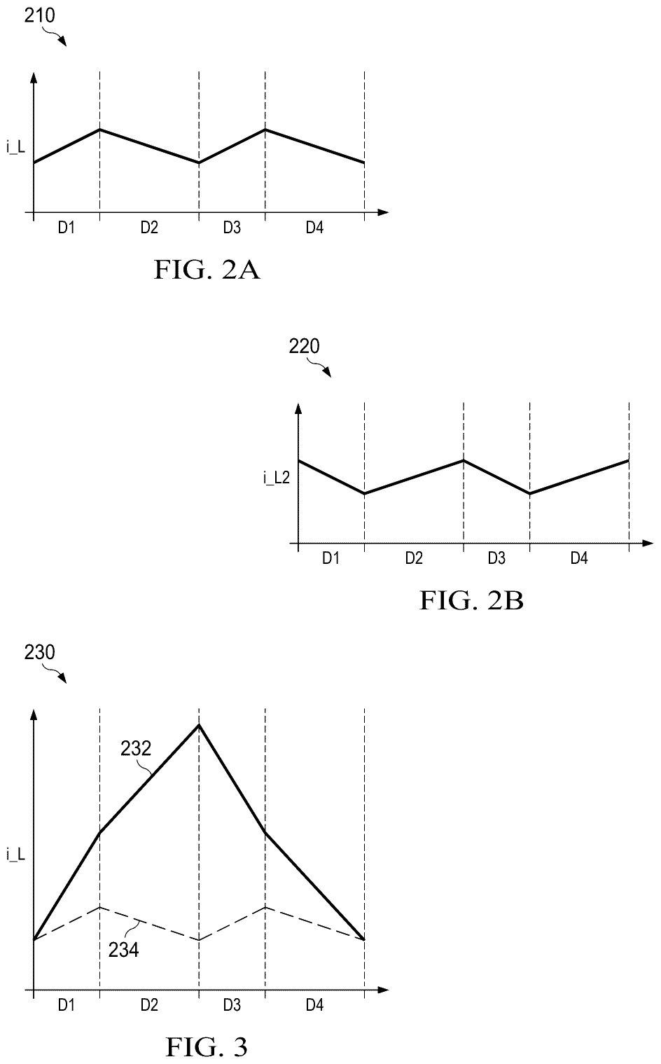

In certain implementations, each circuit phase of the circuit 100 operates across four operational stages (e.g., D1-D4) within each switching cycle. As illustrated, for example, in the associated timing diagram (as shown in FIGS. 2A-2B) during the first operational stage (D1), input voltage is coupled through switches 102a and 102b; thereby, charging capacitor 112 and concurrently increasing current (iL) through at least one winding of the coupled inductor 106. During the second operational stage (D2), switches 104a and 102c disconnect capacitor 112, causing the current (IL) through the coupled inductor 106 to decrease as inductive energy is transferred to load 116 through the output node coupled to additional capacitor 114, ensuring a stable regulated voltage output. In the third operational stage (D3), switches 102c and 104b reconnect capacitor 112, providing energy from capacitor 112 back into coupled inductor 106 and increasing the current (IL). Finally, in the fourth operational stage (D4), switches 104a and 102c again disconnect capacitor 112, causing current (iL) through the coupled inductor 106 to decrease.

In various aspects, the second circuit phase 101b is configured substantially identical to the first circuit phase 101a, and operates approximately 180 degrees out of phase relative to the first circuit phase 101a. Advantageously, such an inverse-phase operation enables significant ripple current cancellation, enhancing overall efficiency. Further, in some cases, the voltage across capacitor 112 is actively maintained at approximately half the input voltage, reducing the rate of current change (di/dt) through coupled inductor 106 during each operational stage. Consequently, this configuration provides substantial improvements, including lower ripple currents, enhanced transient response, and optimized conversion efficiency relative to conventional voltage regulator designs.

Referring FIG. 2A, a graph 210 is shown according to example implementations. As shown, the graph 210 depicts current (IL) behavior in the coupled inductor 106 for the first circuit phase 101a during the four operational stages (D1 through D4), as described above. For instance, the slope during each operational stage represents the rate of change of current through the coupled inductor 106.

In certain aspects, during the first operational stage (D1), the slope of the current increase is determined by the inductance and the voltage difference across the coupled inductor 106. Specifically, the slope can be expressed mathematically as di/dt=(Vin−Vcap−Vout)/L (neglecting minor resistances for simplicity), where Vin is the input voltage, Vcap is the voltage across capacitor 112, Vout is the regulated output voltage, and L represents the inductance of coupled inductor 106. Also, during the second operational stage (D2), the slope becomes negative as capacitor 112 is disconnected, causing the current through coupled inductor 106 to decrease inductively to the load 116, represented by di/dt=−Vout/L. Further, in the third operational stage (D3), the slope mirrors that of D1, with the capacitor 112 reconnecting and supplying stored energy to the coupled inductor 106. As one example, since capacitor 112 voltage (Vcap) is actively regulated at approximately half the input voltage (Vin≈2×Vcap), stages D1 and D3 exhibit substantially equal slopes and equal durations, ensuring balanced energy transfer to and from capacitor 112 and stabilizing its voltage. Lastly, the fourth operational stage (D4) repeats the conditions of D2, again represented by di/dt=−Vout/L, completing the operational cycle.

Referring to FIG. 2B, a graph 220 is shown according to example implementations. As shown, the graph 220 depicts illustrates the current (iL2) behavior in the coupled inductor 106 for the second circuit phase 101b, which operates approximately 180 degrees out of phase with the first circuit phase 101a illustrated in FIG. 2A. As would be appreciated, the operational stages (D1-D4) in the second circuit phase 101b exhibit slopes opposite those described for the first phase 101a, demonstrating how simultaneous yet phase-shifted operation effectively cancels ripple currents. For example, the slopes of current changes are identical in magnitude but opposite in sign to those detailed in FIG. 2A. In particular, the current increase in one phase coincides temporally with the current decrease in the other phase, resulting in significant reduction or near elimination of net ripple current at the circuit 100 output node coupled to capacitor 114 and load 116. Advantageously, these inventive aspects substantially reduce ripple current, significantly improving overall efficiency and reliability compared to conventional single-phase integrated voltage regulators.

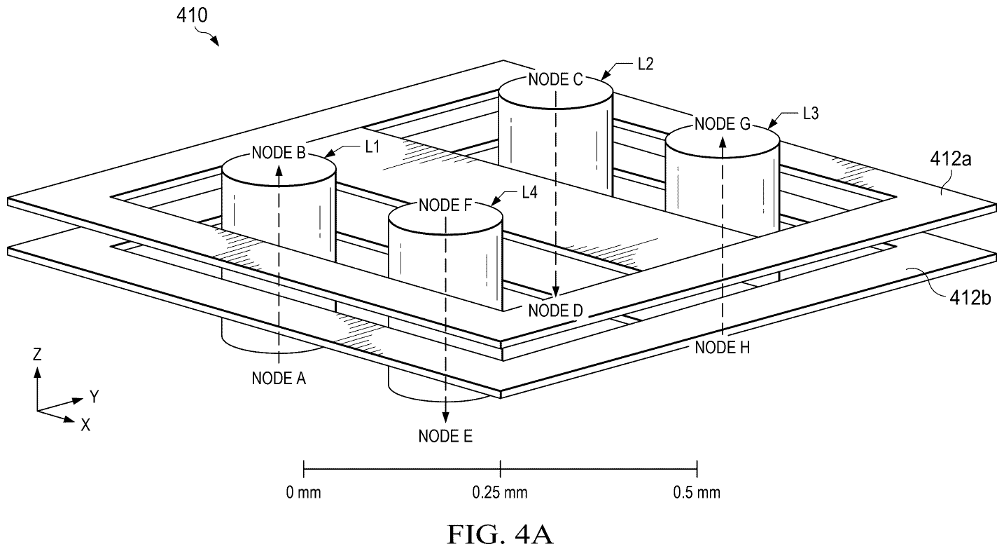

Referring to FIG. 3, a graph 230 is shown according to example implementations As shown, the graph 230 compares current slopes (di/dt) through inductors in a traditional buck converter (e.g., shown as current slopes 232) and the inventive integrated voltage regulator circuit topology (e.g., shown as current slopes 234). Advantageously, the graph 230 demonstrates the improved conversion ratio and reduced ripple current provided by the inventive integrated voltage regulator topology as compared to conventional single-phase buck converters.

For illustrative purposes, assume an input voltage (Vin) of approximately 3 volts, a flying capacitor 112 voltage (Vcap) of approximately 1.5 volts, and an output voltage (Vout) delivered to load 116 of approximately 1 volt. Under these example conditions, a traditional buck converter operating with only two operational stages per switching cycle exhibits a larger voltage differential across its inductor, thus leading to a notably higher rate of current change (di/dt) (e.g., see current slope 232). Specifically, the di/dt in such a traditional buck converter can be calculated as (Vin−Vout)/L, explicitly equating to (3 V−1 V)/L, or 2 V/L.

In contrast, the inventive integrated voltage regulator circuit topology, with its strategic use of flying capacitor 112 and coupled inductor 106 as previously described (see FIGS. 1-2B), significantly reduces the voltage differential across the coupled inductor 106. Accordingly, the inventive scenario achieves a markedly lower di/dt, calculated as (Vin−Vcap−Vout)/L, yielding (3V−1.5V−1V)/L, or 0.5 V/L. Advantageously, this rate of current change is substantially lower (e.g., specifically, four times lower) than that of an example conventional buck converter.

As illustrated by graph 230 in FIG. 3, for example, the traditional buck converter's current slope 232 (di/dt=2 V/L) is noticeably steeper compared to the integrated voltage regulator circuit topology's current slope 234 (di/dt=0.5 V/L). Advantageously, this considerable reduction in di/dt directly translates into smaller ripple currents, reduced inductive losses within the coupled inductor 106, lowered inductance requirements, and overall improved efficiency. Accordingly, the inventive integrated voltage regulator circuit topology provides substantial advantages over conventional single-phase buck converters in terms of efficiency, ripple current suppression, and achievable conversion ratios.

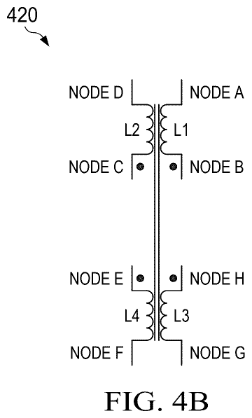

Referring to FIGS. 4A and 4B, diagrams 410, 420 illustrating an example coupled inductor structure (e.g., coupled inductor 106) are depicted according to example implementations. Such a coupled inductor structure 106 can be utilized in various implementations described herein, for instance, with reference to FIGS. 1, 2A, and 2B. As illustrated in FIGS. 4A and 4B, the coupled inductor structure 106 can feature four inductors (e.g., windings), L1, L2, L3, and L4, arranged in two pairs with a shared magnetic core 412a and 412b. In some implementations, each inductor, of inductors L1 L2, L3, and L4, measures 125 micrometers in diameter and 187.5 micrometers in height and can have an inductance range of approximately 1 to 5 nanohenries (nH).

In an example operation, the inductors, L1, L2, L3, and L4, can be paired as follows: L1 and L2 can form one pair, while L3 and L4 can form the other pair. As illustrated by the dotted arrows, current flow in the inductors L1 and L3 can flow from the bottom of L1 and L3 to the top (e.g., from node A to node B on L1, and from node H to node G on L3). Correspondingly, this current flow can represent the secondary inductors providing current flow to the stabilizing capacitor/load. Conversely, current flow in the inductors L2 and LA can flow from the top of the inductors to the bottom (e.g., from node C to node D on L2, and from node F to node E on L4). Correspondingly, this current flow can represent the primary inductors providing current flow from ground.

Across the magnetic core 412a and 412b, node D aligns with node A, node C with node B, node E with node H, and node F with node G. Further, the example inversely coupled inductor pairs 410 can represent a coupled inductor configuration that can enable efficient energy transfer between the inductors, L1, L2, L3, and L4, while maintaining a smaller size compared to traditional voltage regulators. Moreover, the shared magnetic core 412a and 412b can facilitate the coupling of magnetic flux between the inductors that can aid in energy transfer and can enhance the overall performance of the system. Furthermore, the example inversely coupled inductor pairs 410, 420 can optimize space utilization and inductor efficiency for the intended application.

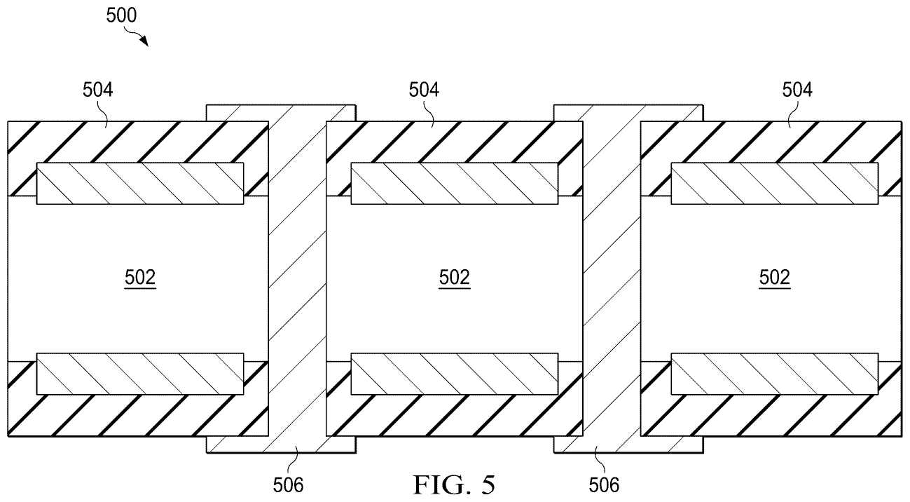

Referring to FIG. 5, a cross-sectional illustration of an example integrated voltage regulator substrate configuration 500 (i.e., structure) is depicted according to example implementations. The illustrated structure 500 includes multiple layers, prominently featuring a rigid substrate core 502 having magnetic core material. In some implementations, the magnetic core material made of rigid substrate core 502 (e.g., magnetic core) facilitates efficient magnetic flux coupling that important for the operation of a coupled inductor within integrated voltage regulators.

In certain aspects, the rigid substrate core 502 can be encapsulated by prepreg layers 504, to serve as insulating and bonding layers, structurally integrating the core 502 within the multilayer substrate configuration 500. Additionally, plated-through holes (PTH) 506 are provided to establish vertical electrical interconnections between conductive layers within the substrate. These plated-through holes 506 ensure effective current flow and electrical connectivity throughout the structure, enhancing the performance and reliability of the integrated voltage regulator. In some implementations, such a multilayered substrate design advantageously provides compact integration of the magnetic core 502 and conductive elements, optimizing space utilization while maintaining structural integrity and electromagnetic efficiency. Such a configuration significantly enhances the performance of the integrated voltage regulators by reducing parasitic inductances and resistances, contributing to improved efficiency, reduced ripple currents, and enhanced thermal management in voltage regulation applications.

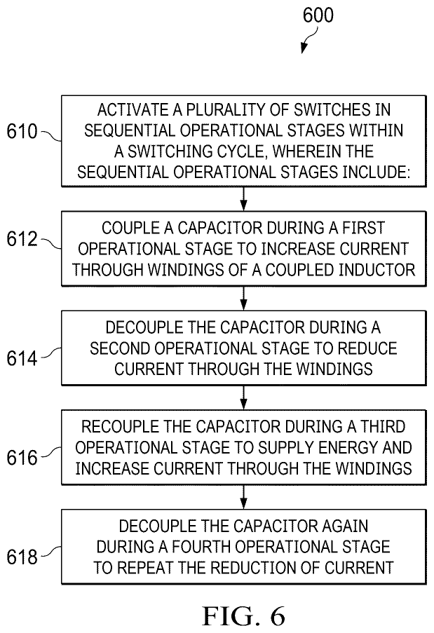

Referring to FIG. 6, a method 600 for voltage regulation in an integrated voltage regulator circuit is illustrated according to example implementations. In certain aspects, the method 600 provides efficient management of ripple current, improved voltage regulation, and enhanced energy transfer efficiency within integrated voltage regulator systems by operating sequential switching stages within each switching cycle. In various implementations, the method 600 utilizes multiple operational stages (e.g., D1-D4 as illustrated previously in FIGS. 1, 2A, and 2B), strategically controlling the coupling and decoupling of a capacitor and coupled inductors, thereby dynamically managing current flow and energy transfer within the integrated voltage regulator circuit.

At block 610, the method 600 includes activating a plurality of switches in sequential operational stages within a switching cycle. In some implementations, the switches activated during these operational stages correspond to coupling and decoupling switches, as described previously with respect to FIG. 1. The sequential operational stages are specifically configured to control energy transfer between the capacitor and the coupled inductors, enabling precise regulation of voltage and current within the integrated voltage regulator circuit.

At block 612, the method includes coupling a capacitor (e.g., flying capacitor 112) during a first operational stage (D1). In certain implementations, coupling the capacitor 112 during this stage increases current through windings (e.g., primary winding 108 and/or secondary winding 110) of coupled inductor 106. Specifically, this coupling enables stored energy within capacitor 112 and input energy from the input voltage source to flow directly into coupled inductor 106, thus increasing the inductive current (IL) during the first operational stage (D1).

Subsequently, at block 614, the capacitor 112 is decoupled during a second operational stage (D2). Decoupling the capacitor 112 during this stage reduces current through the windings (108, 110) of coupled inductor 106, transferring previously stored inductive energy towards an output node coupled to an additional capacitor 114 and load 116. Advantageously, this controlled reduction in current (IL) during the second operational stage (D2) ensures stable and consistent voltage delivery to load 116, effectively stabilizing the regulated output voltage level.

At block 616, the method 600 includes recoupling the capacitor 112 during a third operational stage (D3). Recoupling the capacitor 112 during this stage again supplies energy from capacitor 112 back into the windings (108, 110) of coupled inductor 106, correspondingly increasing current (IL) through these windings. For instance, recoupling of capacitor 112 effectively provides additional energy transfer; thus, enabling inductive current (IL) to rise again, and maintaining energy balance and controlled current flow within each switching cycle.

Finally, at block 618, the method involves decoupling the capacitor 112 once more during a fourth operational stage (D4), repeating the controlled reduction of current (IL) through the windings (108, 110) of the coupled inductor 106. Advantageously, this repeated decoupling action during the fourth operational stage (D4) further stabilizes current flow and maintains consistent voltage regulation at the output node (e.g., at load 116).

In certain implementations, the method 600 further includes activating an additional plurality of switches and a second coupled inductor (e.g., corresponding to second circuit phase 101b, operating approximately 180 degrees out of phase with the first plurality of switches and the first coupled inductor 101a). Advantageously, this out-of-phase operation substantially reduces ripple current at load 116 through inductive cancellation effects between the two coupled inductor structures, thereby significantly enhancing overall efficiency and reducing inductive losses within the integrated voltage regulator circuit topology.

In some implementations, the method 600 further includes regulating the voltage of capacitor 112 to approximately half of the input voltage. For example, maintaining capacitor voltage at approximately half the input voltage advantageously reduces the voltage differential across coupled inductor 106 during each operational stage, significantly reducing the rate of current change (di/dt) through coupled inductor 106, thus lowering ripple currents and improving efficiency.

In various cases, the coupling and the decoupling of capacitor 112 during sequential operational stages are controlled to maintain a substantially constant average output voltage level delivered to load 116. This controlled management of coupling and decoupling actions stabilizes energy transfer, minimizes transient voltage deviations, and ensures highly stable and regulated output voltages. In further aspects, the method 600 dynamically adjusts the duration of each operational stage based on real-time load conditions. For instance, adaptive timing circuitry (not shown) may be utilized to dynamically lengthen or shorten operational stage durations, enabling precise, responsive regulation tailored to varying load demands, thereby enhancing transient response and operational efficiency.

Additionally, the method 600 may include balancing energy transferred to and from capacitor 112 during each switching cycle to maintain a consistent capacitor voltage. Such balancing ensures the capacitor 112 maintains a steady-state operating condition, reducing voltage fluctuations, stabilizing inductive current flow, and promoting robust long-term performance of the integrated voltage regulator system.

Accordingly, the method 600 depicted in FIG. 6 provides an integrated and adaptive approach to voltage regulation, employing strategic sequential coupling and decoupling stages, multi-phase ripple current cancellation, adaptive energy balancing, and precise capacitor voltage control. Collectively, these techniques significantly enhance the efficiency, reliability, transient response, and ripple current management capabilities of integrated voltage regulator circuits.

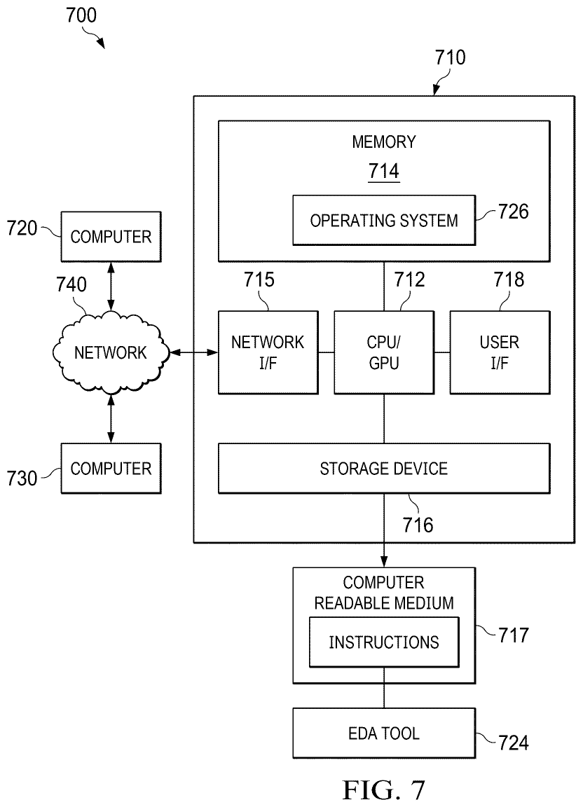

Referring to FIG. 7, example hardware components in a computer system 700 are illustrated according to example implementations. In various aspects, the computer system 700 is configured to facilitate the design, simulation, verification, and optimization of the inventive integrated voltage regulator circuit 100 and associated circuitry described herein. In certain implementations, the computer system 700, representing a computing environment or server system, includes at least one electronic design automation (EDA) tool 724 configured to execute software processes described herein with reference to FIGS. 1 through 6. For instance, EDA tool 724 automates the design, simulation, analysis, and verification of integrated voltage regulator circuits having embedded coupled inductors, sequential operational stages, ripple current cancellation, and adaptive voltage control techniques as illustrated previously in FIGS. 1, 2A-2B, 3, 4A-4B, 5, and 6.

In various aspects, the EDA tool 724 may be integrated within existing electronic design software platforms, automating synthesis, verification, and simulation of the described integrated voltage regulator circuits. More specifically, the EDA tool 724 is configured to perform simulations and validations of transistor-level circuits and netlists for integrated voltage regulator circuitry, including coupled inductors 106, flying capacitors 112, sequentially operated switches (e.g., switches 102, 104), and multi-phase ripple current cancellation circuitry (e.g., circuit phases 101a, 101b). The EDA tool 724 can accurately simulate integrated voltage regulator operation through the four sequential operational stages (D1-D4) within switching cycles (FIGS. 2A-2B), validating voltage regulation performance, ripple current suppression, and capacitor voltage stabilization.

In some implementations, the EDA tool 724 conducts detailed transient analyses and power efficiency simulations to optimize transistor sizes, capacitor dimensions (e.g., flying capacitor 112, additional capacitor 114), switch transistor placement (e.g., switches 102, 104), and magnetic core characteristics of coupled inductors 106. These analyses ensure optimized conversion ratios, lower ripple currents, and minimal inductive energy losses. The physical design steps executed by the EDA tool 724 optimize transistor and inductor layout and routing, reduce total inductance requirements, and ensure efficient area utilization in integrated circuit fabrication.

Additionally, the EDA tool 724 performs critical electrical simulations (e.g., steady-state, transient) and dynamic load evaluations, verifying the integrated voltage regulator's robust performance under varied load conditions. Further, the EDA tool 724 performs formal verification processes and generates test vectors, confirming circuit correctness, reliability, manufacturability, and robustness of the integrated voltage regulator implementations in actual silicon devices.

In certain implementations, procedures described herein, such as voltage regulation method 600 (e.g., with reference to FIG. 6), may be stored as program instructions 717 on a computer-readable medium, for example within a storage device 716 or memory 714. These instructions 717 may be executed by one or more computing devices or servers 710, 720, 730. Each computing device 710, 720, 730 may include any suitable computer, workstation, server, or programmable electronic device. Additionally, computing devices 710, 720, 730 may operate individually or collaboratively in a distributed computing system interconnected via one or more networks 740.

Computer 710 generally includes a central processing unit (CPU) 712 (or alternatively, a graphics processing unit (GPU), neural processing unit (NPU), or other specialized processors) coupled to memory 714. Memory 714 may represent random access memory (RAM), cache memory, non-volatile memory (e.g., flash memory), read-only memory (ROM), or combinations thereof. Additional memory or storage may also be present within computer system 700, such as supplemental cache memory within CPU 712 or virtual memory stored within storage device 716 or other devices interconnected through network 740. Computer 710 also includes a user interface (I/F) 718 for interaction with circuit designers, verification engineers, or other users. Interface 718 typically comprises input devices such as keyboards, mice, touchpads, and microphones, and output devices such as display monitors or LCD/LED screens. Additionally, computer 710 comprises network interface (I/F) 715 connected to network(s) 740, enabling communication and data exchange with remote computing devices or servers 720, 730. Computer 710 operates under control of an operating system 726 stored in memory 714 or storage device 716. Example operating systems include UNIX®, Linux®, Windows®, and others recognized by skilled artisans. Software tools such as EDA tool 724 and instructions 717 for implementing integrated voltage regulator designs and methodologies described herein may execute on CPU 712 or distributed processors across networked computing devices 720, 730.

Databases accessible to computer system 700 may include transistor-level cell libraries, inductor and capacitor technology files, standard cell definitions, and standard design file formats (e.g., OASIS, GDSII, SPICE, EDIF) stored within memory 714, storage device 716, or distributed across computers 720, 730 connected via network 740. System 700 supports semiconductor integrated circuit (IC) designs comprising standard cells, analog or digital intellectual property (IP) blocks, transistor-level custom circuits, coupled inductors, and multi-phase integrated voltage regulator topologies. Leveraging these databases and resources, the EDA tool 724 generates optimized transistor-level netlists and layouts explicitly incorporating the described integrated voltage regulator circuit configurations, sequential switching methodologies, ripple current cancellation strategies, and adaptive energy-balancing techniques. Consequently, the system 700 enables comprehensive optimization and verification, ensuring efficient power conversion, enhanced transient responses, minimized ripple currents, optimized substrate utilization, and robust operation in fabricated integrated voltage regulator implementations.

Concepts described herein may be embodied in computer-readable code for fabrication of apparatus embodying the disclosed concepts. The computer-readable code can be used at one or more stages of a semiconductor design and fabrication process, including electronic design automation (EDA), to fabricate integrated circuits implementing the inventive adaptive feedback circuits. The computer-readable code may define hardware description language (HDL) representations (e.g., Verilog, System Verilog, Chisel, VHDL, FIRRTL, SystemC) or low-level descriptions (e.g., netlists, layouts, Graphics Database System II (GDSII)). Logic synthesis processes can also generate bitstreams loaded into field-programmable gate arrays (FPGAs) for pre-fabrication testing and verification.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, a special purpose computer, or other programmable data processing apparatus to produce a machine, where such instructions may execute via the processor of the computer or other programmable data processing apparatus. The machine is an example of means for implementing the functions/acts specified in the flowchart and/or block diagrams. The computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the functions/acts specified in the flowchart and/or block diagrams.

The computer-readable program instructions may also be loaded onto a computer, other programmable data processing apparatus, or other device to cause a series of operational steps to be performed on the computer, other programmable apparatus or other device to perform a computer implemented process, such that the instructions which execute on the computer, other programmable apparatus, or other device implement the functions/acts specified in the flowchart and/or block diagrams.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which includes one or more executable instructions for implementing the specified logical function(s). In some alternative implementations, the functions noted in a block in a diagram may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts or carry out combinations of special purpose hardware and computer instructions.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Unless otherwise indicated, the terms “first”, “second”, etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one example” means that one or more feature, structure, or characteristic described in connection with the example is included in at least one implementation. The phrase “one example” in various places in the specification may or may not be referring to the same example.

Illustrative, non-exhaustive examples, which may or may not be claimed, of the subject matter according to the present disclosure are provided below. Different examples of the device(s) and method(s) disclosed herein include a variety of components, features, and functionalities. It should be understood that the various examples of the device(s) and method(s) disclosed herein may include any of the components, features, and functionalities of any of the other examples of the device(s) and method(s) disclosed herein in any combination, and all such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A circuit for voltage regulation comprising:
a plurality of switches;
a coupled inductor comprising a primary inductor and a secondary inductor embedded in a common magnetic core; and
a first capacitor, wherein:
the plurality of switches are configured to alternatively couple and decouple the first capacitor and the coupled inductor to regulate voltage delivered to a load.

2. The circuit of claim 1, wherein the circuit is configured to regulate the voltage to the load by selectively operating the plurality of switches in operational stages within each switching cycle.

3. The circuit of claim 1, wherein, in a first operational stage, at least one of the plurality of switches is activated to charge the first capacitor and simultaneously increase a current through at least one of the primary and the secondary inductors of the coupled inductor.

4. The circuit of claim 3, wherein, in a second operational stage, at least one of the plurality of switches is activated to disconnect the first capacitor.

5. The circuit of claim 4, wherein, in a third operational stage, at least two of the switches are activated to reconnect the first capacitor.

6. The circuit of claim 4, wherein, in a fourth operational stage, the first capacitor is disconnected.

7. The circuit of claim 1, wherein the first capacitor is a flying capacitor.

8. The circuit of claim 1, wherein the circuit comprises a first phase, and
further comprising:
a second phase configured with identical elements to the first phase, wherein:
the second phase is operated 180 degrees out of phase from the circuit.

9. The circuit of claim 1, wherein:
the plurality of switches are configured to operate sequentially across multiple stages within each switching cycle to alternately couple and decouple the first capacitor and the coupled inductor to regulate voltage delivered to the load.

10. The circuit of claim 1, wherein the rate of change of current through the coupled inductor during each stage is reduced by maintaining a voltage of the first capacitor at approximately half of the input voltage.

11. A circuit for voltage regulation comprising:
a first integrated voltage regulator comprising a first coupled inductor;
a second integrated voltage regulator comprising a second coupled inductor; wherein:
the first and second coupled inductors are inversely coupled to enable ripple current cancellation between the first and second integrated voltage regulators.

12. The circuit of claim 11, wherein:
the first integrated voltage regulator comprises first switches and a first capacitor;
the first coupled inductor comprises first and second windings arranged within a first common magnetic core;
the second integrated voltage regulator comprises second switches and a second capacitor;
the second coupled inductor comprises first and second windings arranged within a second common magnetic core; and
wherein:
each integrated voltage regulator operates across multiple sequential stages within each switching cycle to alternately couple and decouple their respective capacitors and coupled inductors.

13. The circuit of claim 11, wherein voltages across the capacitor of each respective integrated voltage regulator is maintained at approximately half of an input voltage level.

14. The circuit of claim 11, wherein the inverse coupling of the coupled inductors reduces ripple current through inductive cancellation.

15. A method for voltage regulation comprising:
activating a plurality of switches in sequential operational stages within a switching cycle,
wherein the sequential operational stages comprise:
coupling a capacitor during a first operational stage to increase current through windings of a coupled inductor;
decoupling the capacitor during a second operational stage, reducing current through the windings;
recoupling the capacitor during a third operational stage to supply energy and increase current through the windings; and
decoupling the capacitor during a fourth operational stage, to repeat the reduction of current.

16. The method of claim 15, further comprising:
activating the sequential operational stages by a second plurality of switches and a second coupled inductor approximately 180 degrees out of phase with the first plurality of switches and the first coupled inductor.

17. The method of claim 15, further comprising:
regulating a capacitor voltage to approximately half of an input voltage.

18. The method of claim 15, wherein the coupling and the decoupling of the capacitor are controlled to maintain a substantially constant average output voltage level.

19. The method of claim 15, further comprising:
dynamically adjusting the duration of each operational stage based on load conditions.

20. The method of claim 15, further comprising:
balancing an energy transferred to and from the capacitor during each switching cycle to maintain consistent capacitor voltage.
